(19) United States
(12) Patent Application Publication
(10) Pub. No.: US 2014/0149226 A1
(43) Pub. Date: May 29, 2014

(54) ADVERTISEMENT DELIVERY MANAGEMENT APPARATUS AND ADVERTISEMENT DELIVERY MANAGEMENT METHOD

(71) Applicant: YAHOO JAPAN CORPORATION, Tokyo (JP)

(72) Inventors: Kazuhiko SHIMURA, Tokyo (JP); Koji TSUKAMOTO, Tokyo (JP)

(73) Assignee: YAHOO JAPAN CORPORATION, Tokyo (JP)

(21) Appl. No.: 14/086,489

(22) Filed: Nov. 21, 2013

(30) Foreign Application Priority Data
Nov. 27, 2012 (JP) 2012-258777

(51) Int. Cl. G06Q 30/02

(52) U.S. Cl. CPC G06Q 30/0269
USPC 705/14.66

(57) ABSTRACT

An advertisement delivery management apparatus according to the present disclosure includes a predictive information storage, a counting unit, and an allocating unit. The predictive information storage unit stores information including user attributes of a plurality of delivery target users predicted as a future advertisement delivery destination. The counting unit counts a total of the number of user attributes of delivery target users which are not allocated on an advertisement delivery order request among the plurality of delivery target users. The an allocating unit allocates the delivery target user on the advertisement delivery order request so that a decrease in a total of the number of user attributes counted by the counting unit is minimized before and after the delivery target user is allocated on the advertisement delivery order request.

### CROSS-REFERENCE TO RELATED APPLICATIONS

The present application claims priority to and incorporates by reference the entire contents of Japanese Patent Application No. 2012-258777 filed in Japan on Nov. 27, 2012.

### BACKGROUND OF THE INVENTION

1. Field of the Invention

The present invention relates to an advertisement delivery management apparatus and an advertisement delivery management method.

2. Description of the Related Art

In recent years, with the rapid spread of a network such as the Internet, advertisement delivery using a network has been actively performed. As a form of such advertisement delivery, known is display advertising of displaying an advertisement using an image, video, or the like on a certain space in a page (hereinafter, referred to as an “advertisement delivery target page”) of an advertisement delivery target.

In the display advertising, an advertisement is delivered to a user having a user attribute (a sex, an age, an interest, or the like) designated by an advertiser, and thus effective advertisement delivery is performed (for example, see Japanese Patent Application Laid-open No. 2011-238020).

In the above-mentioned advertisement delivery, when the user attribute of the user who accessed the advertisement delivery target page is identical to the user attribute designated by the advertiser, an advertisement is delivered. Thus, it is desirable to predict a delivery target user who is a future advertisement delivery destination as a future log together with a user attribute and accept an order from the advertiser based on the future log.

However, when the delivery target user of the future advertisement delivery destination has a plurality of user attributes, there are cases in which it is difficult to accept a new order from the advertiser depending on a method of allocating the delivery target user on the advertisement delivery order.

### SUMMARY OF THE INVENTION

According to an exemplary embodiment, an advertisement delivery management apparatus includes a predictive information storage unit, a counting unit, and an allocating unit. The predictive information storage unit stores information including user attributes of a plurality of delivery target users predicted as a future advertisement delivery destination. The counting unit counts a total of the number of user attributes of delivery target users which are not allocated on an advertisement delivery order request among the plurality of delivery target users. The allocating unit allocates the delivery target user on the advertisement delivery order request so that a decrease in a total of the number of user attributes counted by the counting unit is minimized before and after the delivery target user is allocated on the advertisement delivery order request.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIGS. 1A and 1B are explanatory views of an advertisement delivery management process according to an embodiment;

FIG. 2 is a diagram illustrating a configuration of an advertisement delivery management apparatus according to an embodiment;

FIG. 3 is a diagram illustrating an exemplary advertising information table;

FIG. 4 is a diagram illustrating an exemplary user information table;

FIG. 5 is a diagram illustrating an exemplary access log table;

FIG. 6 is a diagram illustrating an exemplary future log table;

FIG. 7 is a diagram for describing a method of obtaining a total of the number of user attributes;

FIG. 8 is a diagram illustrating an advertisement delivery management process flow of the advertisement delivery management apparatus according to an embodiment; and

FIG. 9 is a diagram illustrating an exemplary allocation process flow of an advertisement delivery management apparatus according to an embodiment.

### DETAILED DESCRIPTION OF THE PREFERRED EMBODIMENTS

Hereinafter, a mode (hereinafter, referred to as an “embodiment”) for carrying out an advertisement delivery management apparatus and an advertisement delivery management method according to the present application will be described in detail with reference to the appended drawings. The following embodiment is not intended to limit the advertisement delivery management apparatus and the advertisement delivery management method according to the present application. Further, “database” is hereinafter referred as a “DB.”

### 1. ADVERTISEMENT DELIVERY MANAGEMENT PROCESS

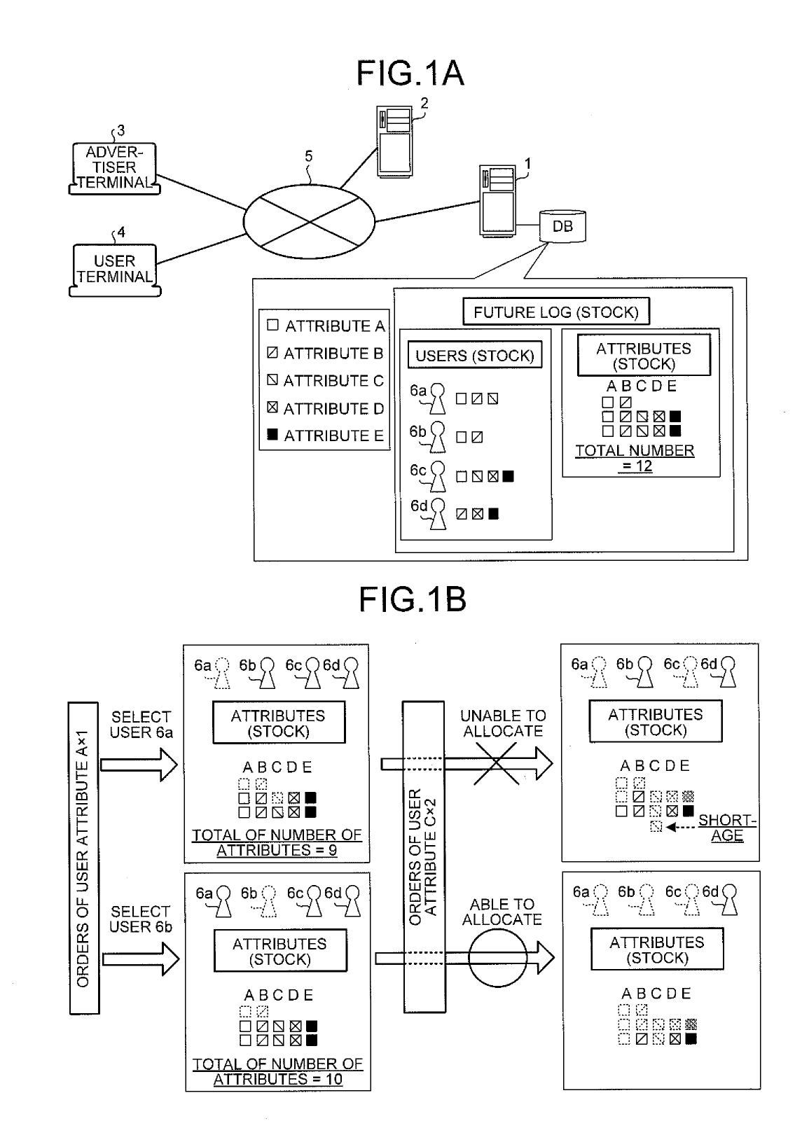

First of all, an advertisement delivery management process according to an embodiment will be described. FIGS. 1A and 1B are explanatory views of the advertisement delivery management process according to an embodiment, and a delivery target user is appropriately allocated to an order from an advertiser through the advertisement delivery management process.

An advertisement delivery management system according to an embodiment includes an advertisement delivery management apparatus 1, an information delivery apparatus 2, an advertiser terminal 3, and a user terminal 4 as illustrated in FIG. 1A. The advertisement delivery management apparatus 1, the information delivery apparatus 2, the advertiser terminal 3, and the user terminal 4 are connected with one another via a communication network 5. For example, the communication network 5 is an Internet protocol (IP) network such as the Internet. There are a plurality of advertiser terminals 3 and a plurality of user terminals 4, but in FIG. 1A, one advertiser terminal 3 and one user terminal 4 are illustrated for convenience of description.

The advertiser terminal 3 is a terminal apparatus of an advertiser who desires to do advertisement delivery, and transmits an order (hereinafter, referred to as an “order request”) of an advertisement, which is desired to be delivered to the user terminal 4 of a user having a certain user attribute, to the advertisement delivery management apparatus 1. Specifically, the advertiser terminal 3 transmits an order request including advertising information which the advertiser desires to post on an advertisement delivery target page and information of a user attribute to be designated as a delivery destination to the advertisement delivery management apparatus 1. As the advertising information, for example, there are two-dimensional (2D) content or three-dimensional (3D) content such as a banner advertisement, a text advertisement, or a video advertisement.

The user terminal 4 is a terminal apparatus of a user who accesses the advertisement delivery management apparatus 1 and the information delivery apparatus 2. When there is access from the user terminal 4, the information delivery apparatus 2 transmits an advertisement delivery target page such as a web page to the user terminal 4. The advertisement delivery target page includes a uniform resource locator (URL) of the advertising information, and the user terminal 4 transmits an advertisement request to the advertisement delivery management apparatus 1 based on the URL.

The advertisement delivery management apparatus 1 performs a process from acceptance of the advertisement delivery order to delivery thereof by performing a process of accepting an order request, a process of allocating a user attribute to the accepted order request, and a process of delivering advertising information designated by the order request.

The advertisement delivery management apparatus 1 stores information including user attributes of a plurality of delivery target users predicted as the future advertisement delivery destination in a DB as a future log, and performs the order request acceptance process and the user attribute allocation process based on the future log.

In the example illustrated in FIG. 1A, information including user attributes of delivery target users 6a to 6d in a DB as a future log. The delivery target user 6a has user attributes A, B, and C, the delivery target user 6b has the user attributes A and B, the delivery target user 6c has the user attributes A and C to E, and the delivery target user 6d has the user attributes B, D, and E.

The advertisement delivery management apparatus 1 counts a total of the number of user attributes of delivery target users (which are hereinafter referred to as “non-allocated users” as well) 6a to 6d which are not allocated on the order request. In the future log illustrated in FIG. 1A, users having the user attribute A are the delivery target users 6a to 6c, users having the user attribute B are the delivery target users 6a, 6b, and 6d, users having the user attribute C are the delivery target users 6a and 6c, and users having the user attributes D and E are the delivery target users 6c and 6d.

Thus, the number of the user attributes A and the number of the user attributes B are “3,” the number of the user attributes C, the number of the user attributes D, and the number of the user attributes E are “2,” and thus the advertisement delivery management apparatus 1 counts “12” as a total of the number of user attributes.

The advertisement delivery management apparatus 1 appropriately allocates the delivery target user on the order request by allocating the delivery target user so that a decrease in a total of the number of user attributes is minimized before and after the delivery target user is allocated on the order request.

For example, it is assumed that there is an order request (which is hereinafter referred to as an “order request X”) for requesting advertisement delivery to a single user having the user attribute A. Because the users having the user attribute A are the three delivery target users 6a to 6c and thus advertisement delivery can be performed on the order request X, the advertisement delivery management apparatus 1 accepts the order request X.

It is possible to allocate the order request X of the user attribute A to any one of the delivery target users 6a to 6c as well. For example, when the order request X is allocated to the delivery target user 6a, since the number of the user attributes of the delivery target user 6a is “3,” a total of the number of user attributes is “9” as illustrated in FIG. 1B.

Meanwhile, when the order request X is allocated to the delivery target user 6b, since the number of the user attributes of the delivery target user 6b is “2,” a total of the number of user attributes is “10.” Further, although not illustrated, when the order request X is allocated to the delivery target user 6c, since the number of the user attributes of the delivery target user 6c is “4,” a total of the number of user attributes is “8.”

Thus, the advertisement delivery management apparatus 1 allocates the delivery target user 6b which causes a decrease in a total of the number of user attributes to be minimum, that is, “2 (=12−10)” before and after the delivery target user is allocated on the order request X on the order request X.

It is assumed that after accepting the order request X, there is an order request (hereinafter, referred to as an “order request Y”) for requesting advertisement delivery to two users having the user attribute C. If the delivery target user 6a is allocated on the order request X, since the non-allocated user having the user attribute C is only the delivery target user 6c, it is difficult to accept the order request Y.

Meanwhile, the advertisement delivery management apparatus 1 can accept the order request Y by allocating the delivery target user 6b on the order request X since the non-allocated users having the user attribute C are the delivery target users 6a and 6c.

The advertisement delivery management apparatus 1 according to an embodiment allocates the delivery target user on the order request so that a decrease in a total of the number of user attributes is minimum, and thus can leave the non-allocated user which is largest in a total of the number of user attributes. Thus, since choices of allocation of the delivery target user on the order request increase and the likelihood of acceptance of a future order request increases, it is possible to suppress sales opportunity loss.

Next, a concrete configuration and a detailed process of the advertisement delivery management apparatus 1 which performs the advertisement delivery management process will be described with reference to the appended drawings.

### 2. CONFIGURATION OF ADVERTISEMENT DELIVERY MANAGEMENT APPARATUS 1

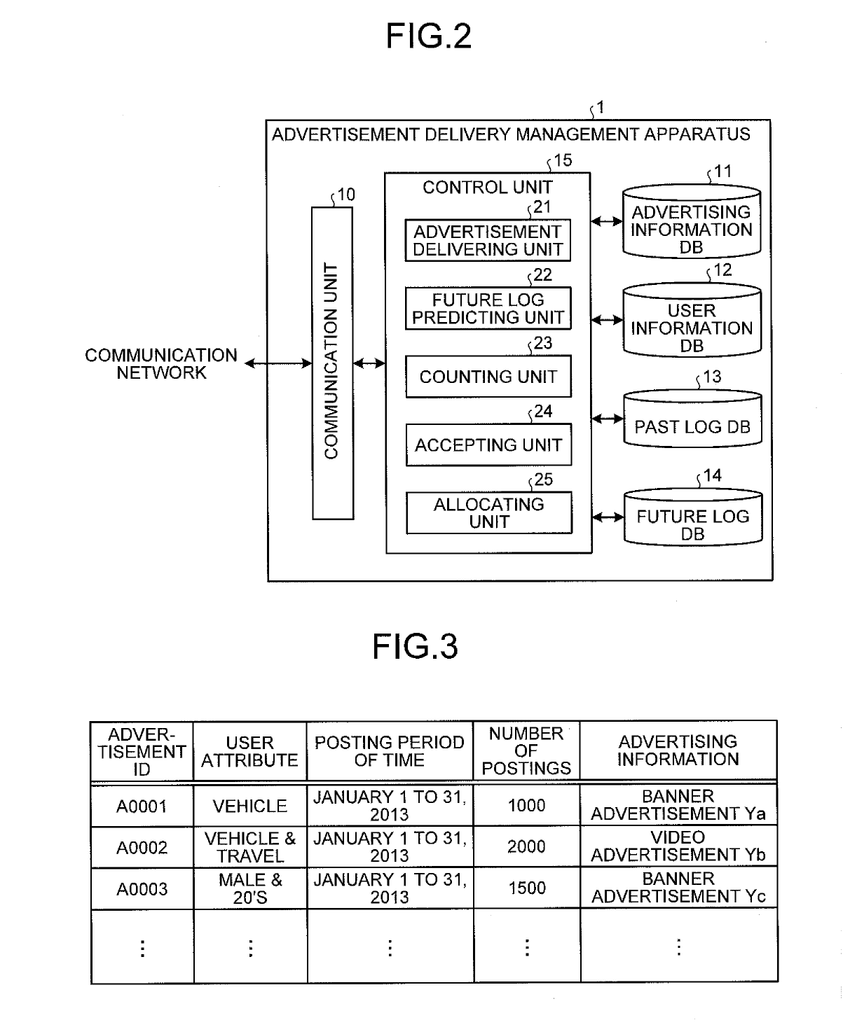

FIG. 2 is a diagram illustrating a configuration of the advertisement delivery management apparatus 1 according to an embodiment. The advertisement delivery management apparatus 1 includes a communication unit 10, an advertising information DB 11, a user information DB 12, a past log DB 13, a future log DB 14, and a control unit 15 as illustrated in FIG. 2. The control unit 15 includes an advertisement delivering unit 21, a future log predicting unit 22, a counting unit 23, an accepting unit 24, and an allocating unit 25.

The communication unit 10 is an interface such as a network interface card (NIC). The control unit 15 transmits or receives various kinds of information to or from the advertiser terminal 3 or the user terminal 4 via the communication network 5 through the communication unit 10. The advertising information DB 11, the user information DB 12, the past log DB 13, and the future log DB 14 are implemented by hard disks, semiconductor memory devices such as random access memory (RAM) or flash memory, or storage devices such as optical disks.

The control unit 15 is implemented by an integrated circuit (IC) such as an application specific integrated circuit (ASIC) or a field programmable gate array (FPGA). The control unit 15 functions as the advertisement delivering unit 21, the future log predicting unit 22, the counting unit 23, the accepting unit 24, and the allocating unit 25 as a program stored in an internal storage device is executed by a central processing unit (CPU) or a micro processing unit (MPU) using RAM as a work area. The configuration of the control unit 15 is not limited to the above configuration, and may have any other configuration capable of performing information processing which will be described later.

Advertisement Delivering Unit 21

When there is an advertising information delivery request from the user terminal 4, the advertisement delivering unit 21 acquires advertising information corresponding to the user attribute of the user of the user terminal 4 from the advertising information table of the advertising information DB 11, and transmits the acquired advertising information from the communication unit 10 to the user terminal 4 of the delivery request resource.

FIG. 3 is a diagram illustrating an exemplary advertising information table stored in the advertising information DB 11. The advertising information table includes information associated with a “user attribute,” a “posting period of time,” the “number of postings,” and “advertising information” for each “advertisement ID” as illustrated in FIG. 3.

The “advertisement ID” is identification information allocated on each accepted order request. The “user attribute” is a user attribute designated by the order request, the “posting period of time” is a delivery period of time of advertising information designated by the order request, and the “number of postings” is the number of deliveries of the advertising information designated by the order request. Further, the “advertising information” is advertising information designated by the order request.

For example, an advertisement ID “A0001” represents that a user attribute of the delivery target is a “vehicle,” the delivery period of time of the advertising information is “Jan. 1 to 31, 2013,” the number of deliveries of the advertising information is “1000 times,” and the advertising information is “banner advertisement Ya.” Further, when it is within the delivery period of time of the advertising information but the number of deliveries of the advertising information exceeds “1000 times,” the process of delivering the advertising information on the order request ends.

For example, when the user of the user terminal 4 who has made the advertising information delivery request has the user attribute “vehicle,” the advertisement delivering unit 21 acquires the advertising information “banner advertisement Ya” of the advertisement ID “A0001” from the advertising information table of the advertising information DB 11, and transmits the acquired advertising information “banner advertisement Ya” to the user terminal 4 of the delivery request source.

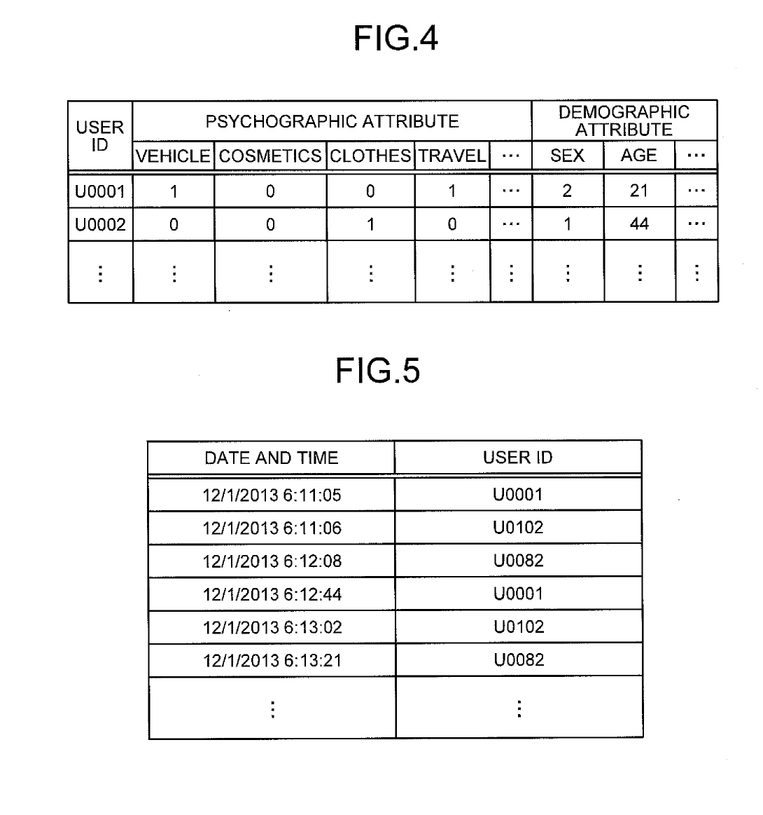

The user attribute of the user of the user terminal 4 is determined based on the user information table of the user information DB 12. FIG. 4 is a diagram illustrating an exemplary user information table stored in the user information DB 12. The user information table includes information such as a “user ID,” a “psychographic attribute,” and a “demographic attribute” as illustrated in FIG. 4.

The “user ID” is identification information used to identify the user using the user terminal 4. For example, the “user ID” corresponds to user identification information set to a hypertext transfer protocol cookie (HTTP cookie) exchanged between the advertisement delivery management apparatus 1 and the user terminal 4.

The “psychographic attribute” is information representing the user's value, lifestyle, character, preference, or the like. For example, the “psychographic attribute” is classified into attribute classifications such as “vehicle,” “cosmetics,” “clothes,” and “travel.” In the example illustrated in FIG. 4, when the user's preference is relatively high in each attribute classification, “1” is stored, and otherwise, “0” is stored. The “psychographic attribute” is not limited to the example of the attribute classifications illustrated in FIG. 4, and may include various kinds of attribute classifications such as an economy, politics, baseball, soccer, other sports, sweets, a personal computer (PC), white goods, and furniture.

The “demographic attribute” represents demographical user attribute information. For example, the “demographic attribute” is classified into attribute classifications such as “sex” and “age.” The “sex” illustrated in FIG. 4 stores “1” when the user is female and stores “2” when the user is male. Further, the “age” stores the user's age. The “demographic attribute” is not limited to the attribute classifications illustrated in FIG. 4, and may include various kinds of attribute classifications such as the user's occupation, family structure, annual income, address, hometown, and academic background.

For example, when the user of the user ID “U0001” illustrated in FIG. 4 has made the advertising information delivery request from the user terminal 4, the user's user attributes are determined to be “vehicle,” “travel,” “male,” “age of 21,” and the like. Further, for example, when the user of the user ID “U0002” illustrated in FIG. 4 has made the advertising information delivery request from the user terminal 4, the advertisement delivering unit 21 determines that the user's user attributes are “clothes,” “female,” “age of 44,” and the like.

Further, the advertisement delivering unit 21 sets the user ID of the user who has made the advertising information delivery request to the access log table of the past log DB 13. FIG. 5 is a diagram illustrating an exemplary access log table stored in the past log DB 13.

The access log table is a table to which information (which is hereinafter referred to as a “past log” as well) in which a date and time at which the user transmits the advertising information delivery request to the advertisement delivery management apparatus 1 is associated with the user ID is set as illustrated in FIG. 5. The advertisement delivering unit 21 updates the access log table each time the advertising information delivery request is received from the user terminal 4.

Future Log Predicting Unit 22

The future log predicting unit 22 determines a plurality of delivery target users predicted as a future advertisement delivery destination based on the access log table stored in the past log DB 13, and sets user information of the determined delivery target user to the future log table of the future log DB 14.

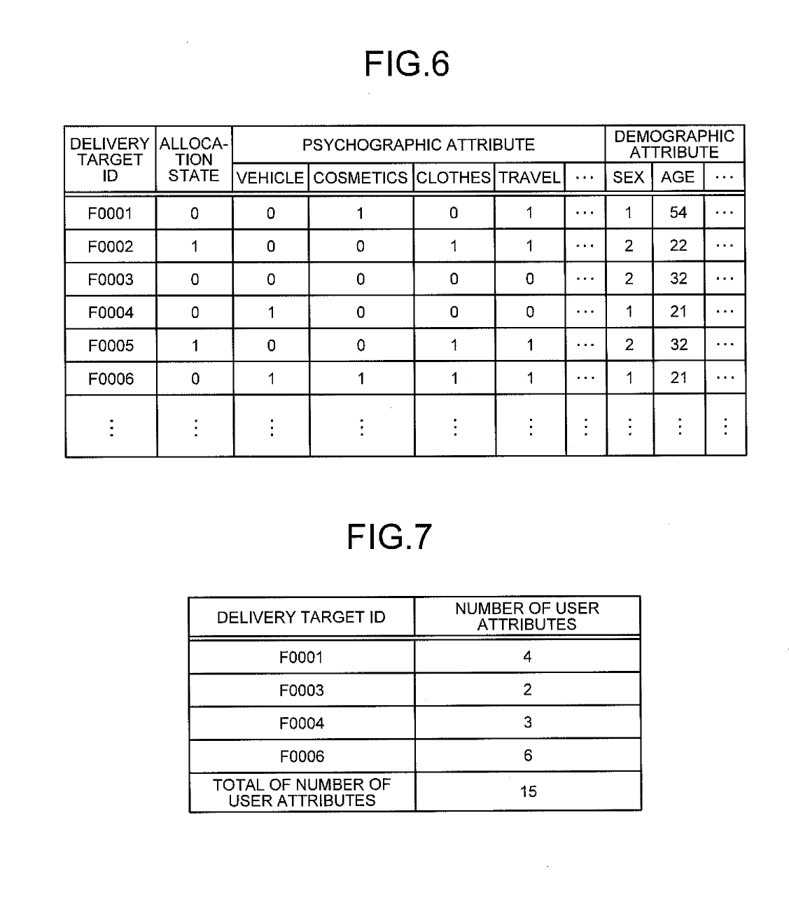

FIG. 6 is a diagram illustrating an exemplary future log table stored in the future log DB 14. Information (which is hereinafter referred to as a “future log” as well) related to a delivery target user predicted as an advertisement delivery destination during a certain future period of time is set to the future log table as illustrated in FIG. 6. The future log table illustrated in FIG. 6 includes future log information such as “delivery target ID,” “allocation state,” “psychographic attribute,” and “demographic attribute.”

The “delivery target ID” is identification information allocated for each delivery target user predicted as a future advertisement delivery destination. The delivery target user is a virtual user different from the user set to the user information table of the user information DB 12.

The “allocation state” is information representing whether a corresponding delivery target user is allocated on the order request. “1” is stored when the corresponding delivery target is allocated on the order request, but “0” is stored when the corresponding delivery target user is not allocated on the order request.

The “psychographic attribute” and the “demographic attribute” have the same items as in the user information table of the user information DB 12. Further, the user set to the user information table may be estimated as the delivery target user, and the user ID may be used as the delivery target ID. In this case, information of the “psychographic attribute” and the “demographic attribute” may be acquired from the user information table based on the user ID.

The future log predicting unit 22 may predict the delivery target user serving as the advertisement delivery destination during a certain future period of time based on access logs during the same period of time one year ago or access logs during a certain past period of time from the present. For example, the future log predicting unit 22 may estimate the user who has made the advertising information delivery request during past one month from the present as the delivery target user of a future one month.

Further, the future log predicting unit 22 may perform a statistical process on the past log set to the access log table, determine the tendency toward the delivery target user of the future advertisement delivery destination, and predict the future log based on the determination result. In this case, for example, the tendency of the delivery target user may be determined by additionally considering variation information such as the weather or the temperature.

Further, the future log predicting unit 22 can set the predicted future log to the future log table, but may set the future log acquired from an external device through the communication unit 10 to the future log table.

Counting Unit 23

The counting unit 23 counts a “total of the number of user attributes” of the non-allocated users among a plurality of delivery target users set to the future log table. The non-allocated user is a delivery target user whose “allocation state” is “0” in the future log table.

The “total of the number of user attributes” is a sum value of the “numbers of user attributes” of the non-allocated users. For example, when the number of the non-allocated users is 1000, a number obtained by adding the “numbers of user attributes” of the 1000 non-allocated users is the “total of the number of user attributes.”

The “number of user attributes” represents the number of delivery target users which are effectively set according to the respective attribute classifications of the user attribute. The attribute classification means each of “vehicle,” “cosmetics,” “clothes,” “travel”, and the like in case of the “psychographic attribute,” and means each of “sex”, “age”, and the like in case of the “demographic attribute.”

Further, the effectively set delivery target user is a delivery target user in which “1” is set to the corresponding attribute classification in case of the “psychographic attribute.” The effectively set delivery target user is a delivery target user in which information is set to the attribute classification in case of the “demographic attribute.”

For example, the “psychographic attribute” is assumed to have four attribute classifications of “vehicle,” “cosmetics,” “clothes,” and “travel,” and the “demographic attribute” is assumed to have two attribute classifications of “sex” and “age.” In this case, a maximum value of the “number of user attributes” is “6.”

Further, the delivery target users which are not allocated on the order request are assumed to be delivery target users of the delivery target IDs “F0001,” “F0003,” “F0004,” and “F0006,” and the remaining delivery target users are assumed to be allocated on the order request as illustrated in FIG. 6.

In this case, the “number of user attributes” of the delivery target users corresponding to the respective delivery target IDs “F0001,” “F0003,” “F0004,” and “F0006” are “4,” “2,” “3,” and “6” as illustrated in FIG. 7. Thus, the “total of the number of user attributes” which is a sum value of the “numbers of user attributes” of the delivery target users which are not allocated on the order request is “15 (=4+2+3+6)” as illustrated in FIG. 7.

Further, the counting unit 23 can count the “total of the number of user attributes” only for the “psychographic attribute,” and can count the “total of the number of user attributes” only for the “demographic attribute.” Further, the counting unit 23 can count the “total of the number of user attributes” only for some attribute classifications of the “psychographic attribute” or the “demographic attribute.”

Further, the counting unit 23 counts the number of the non-allocated users having the user attribute (which is hereinafter referred to as a “designated user attribute” as well) designated by the order request. For example, when the designated user attribute is “vehicle,” the number of delivery target users in which “1” is set to the attribute classification of “vehicle” in the future log table is counted.

Further, the counting unit 23 performs counting using a combination of two or more user attributes in which the frequency of designation by the order request is a threshold value or more as one user attribute (which is hereinafter referred to as a “combination user attribute” as well). For example, the counting unit 23 performs counting using a combination of “clothes” and “travel” as one user attribute when the combination of “clothes” and “travel” is high in the frequency of designation by the order request.

Information of the order request accepted by the accepting unit 24 is set to the advertising information table of the advertising information DB 11, and the counting unit 23 can determine a combination of two or more user attributes in which the frequency of designation by the order request is a threshold value or more based on the advertising information table.

For example, the counting unit 23 obtains the sum of the number of postings designated by a past order request as a first sum value based on the advertising information table, and obtains the sum of the number of postings designated by the past order request for each combination of two or more user attributes as a second sum value. Further, the counting unit 23 counts a combination of user attributes in which the ratio of the second sum value to the first sum value is a certain threshold value or more as one user attribute.

When the combination of “clothes” and “travel” is high in the frequency of designation by the order request and the future log table is in the state illustrated in FIG. 6, “clothes & travel” is used as the user attribute of the delivery target user of the delivery target ID “F0002” rather than “clothes” and “travel.”

A combination of two or more user attributes in which the frequency of designation by the order request is the threshold value or more may be set to the user information DB 12 from an external apparatus or the like instead of being determined by the counting unit 23.

Accepting Unit 24

The accepting unit 24 determines whether the order request received from the advertiser terminal 3 is to be accepted based on the future log set to the future log table, and transmits an order acceptance response to the advertiser terminal 3 when the order request is determined to be accepted.

The order request received from the advertiser terminal 3 includes the designation information such as the user attribute and the number of postings as described above. The counting unit 23 counts the number of delivery target users having the user attribute designated by the order request as described above, and the accepting unit 24 accepts the order request received from the advertiser terminal 3 when the counting result by the counting unit 23 is the number of postings designated by the order request or more.

For example, when the user attribute designated by the order request is “vehicle” and the number of postings is “100,” the counting unit 23 counts the number of the delivery target users in which “1” is set to the attribute classification of “vehicle” in the future log table. The accepting unit 24 accepts the order request received from the advertiser terminal 3 when the counting result by the counting unit 23 is “100” or more but does not accept the order request received from the advertiser terminal 3 when the counting result by the counting unit 23 is less than “100.”

Further, for example, when the number of the non-allocated users is the certain value or less or when the number of the non-allocated users having a combination user attribute is the certain value or less, the accepting unit 24 may divide the combination user attribute into a plurality of user attributes. Through this operation, it is possible to increase the total number of the user attributes, and as a result, it is possible to reduce a possibility that the order request designating the combination user attribute will be accepted, and thus it is possible to increase a possibility that other order requests will be accepted.

Allocating Unit 25

The allocating unit 25 allocates the delivery target user on the new advertisement delivery order request accepted by the accepting unit 24 so that a decrease in the total of the number of user attributes counted by the counting unit 23 is minimized before and after the delivery target user is allocated on the order request. The allocating unit 25 deals with the combination user attribute as one user attribute, similarly to the counting unit 23.

Specifically, when the new advertisement delivery order request is accepted by the accepting unit 24, the allocating unit 25 acquires a total of the number of the user attributes of the non-allocated users among a plurality of delivery target users set to the future log table from the counting unit 23 as a first total number.

Further, the allocating unit 25 selects the non-allocated users having the user attribute designated by the order request by the number of postings designated by the order request, and acquires a total of the number of the user attributes of the remaining non-allocated users excluding the selected non-allocated users from the counting unit 23 as a second total number.

The allocating unit 25 can maximize the second total number and minimize a result of subtracting the second total number from the first total number by selecting the non-allocated user sequentially from the non-allocated user which is small in the number of user attributes. Through this operation, it is possible to increase choices of allocation of the delivery target user on the future order request.

Further, the allocating unit 25 may select, by the number of postings designated by the order request, the non-allocated user having the user attribute designated by the order request so that the second total number can be maximized under a certain limitation.

For example, a limitation in which the non-allocated users are allocated so that the decrease in the total of the number of user attributes is minimized within a range in which a decrease rate of user attributes other than user attributes designated by the order request is a certain rate or less may be set as the certain limitation. For example, a decrease rate of user attributes other than user attributes designated by the order request is assumed to become a certain rate or less by selecting the non-allocated user sequentially from the non-allocated user which is small in the number of user attributes. In this case, the allocating unit 25 can cause the decrease rate to be a certain rate by reducing a selection rate of the non-allocated user having the user attribute which is large in the decrease rate.

Further, a limitation in which the non-allocated users are allocated so that the decrease in the total of the number of user attributes is minimized within a range in which a decrease rate of an expectation value at which all the user attributes are allocated is a certain value or less when the user attributes are designated randomly or according to a certain rule on the advertisement delivery order request may be set as the certain limitation.

### 3. PROCESS FLOW OF ADVERTISEMENT DELIVERY MANAGEMENT APPARATUS 1

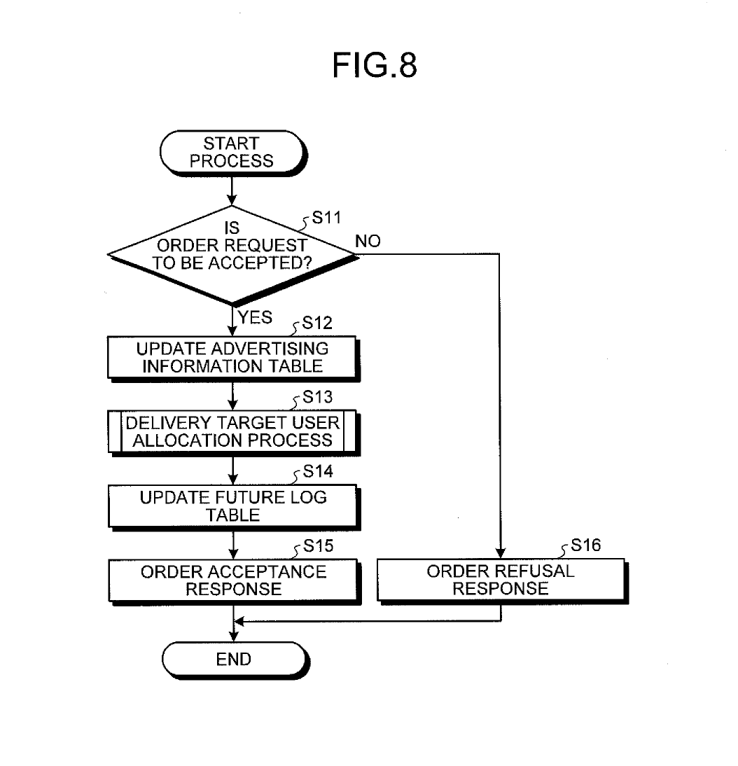

Next, a procedure of an advertisement delivery management process performed by the advertisement delivery management apparatus 1 according to an embodiment will be described. FIG. 8 is a diagram illustrating an advertisement delivery management process flow of the advertisement delivery management apparatus 1 according to an embodiment.

As illustrated in FIG. 8, when the order request is received from the advertiser terminal 3, the control unit 15 of the advertisement delivery management apparatus 1 determines whether the order request received from the advertiser terminal 3 is to be accepted based on the future log set to the future log table (step S11). For example, the control unit 15 counts the number of user attributes designated by the order request among the user attributes of the non-allocated user set to the future log table, and determines that the order request is accepted when the counted number is the number of postings designated by the order request or more.

When it is determined that the order request received from the advertiser terminal 3 is accepted (Yes in step S11), the control unit 15 sets information included in the order request to the advertising information table and updates the advertising information table (step S12). Further, the information included in the order request includes the user attribute, the posting period of time, the number of postings, advertising information, and the like, and the information is set to the advertising information table.

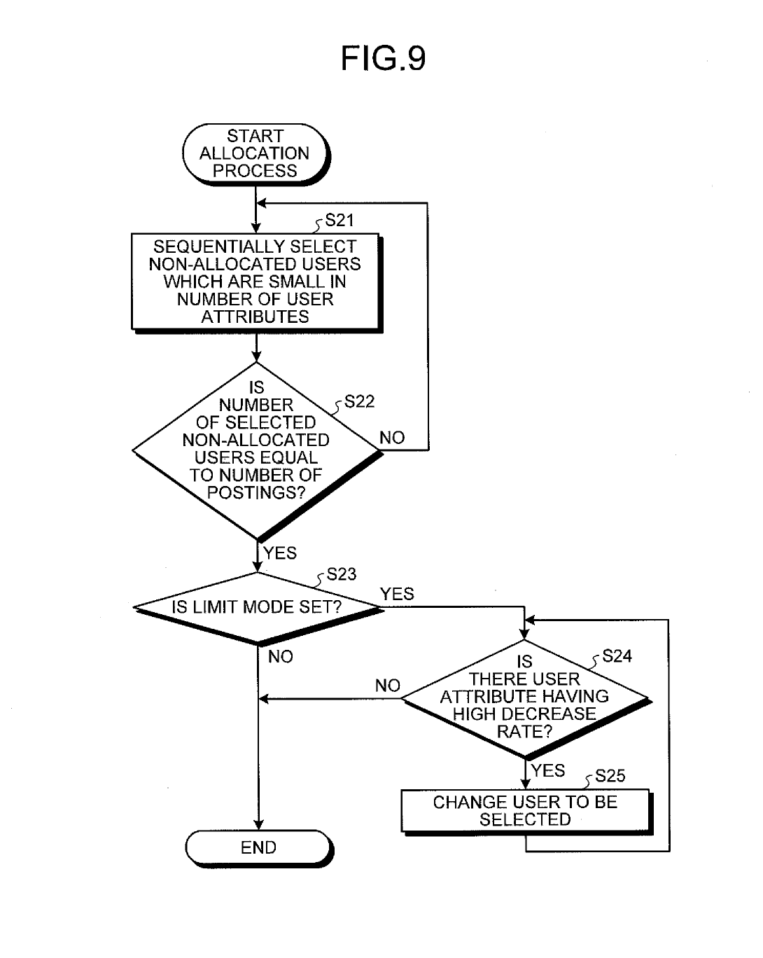

Then, the control unit 15 performs the delivery target user allocation process (step S13). The allocation process is a process of allocating the non-allocated user having the user attribute designated by the order request on the order request such as a process of steps S21 to S25 of FIG. 9 which will be described later.

Then, the control unit 15 updates the future log table based on the result of the allocation process of step S13 (step S14). Specifically, the control unit 15 changes the non-allocated user allocated on the order request among the non-allocated users set to the future log table to the allocated user. The changing of the non-allocated user to the allocated user is performed by changing the “allocation state” from “0” to “1.”

Thereafter, the control unit 15 transmits the order acceptance response to the advertiser terminal 3 through the communication unit 10 (step S15), and then ends the advertisement delivery management process. Meanwhile, when it is determined in step S11 that the order request received from the advertiser terminal 3 is not to be accepted (No in step S11), the control unit 15 transmits the order refusal response to the advertiser terminal 3 through the communication unit 10 (step S16), and then ends the advertisement delivery management process.

Next, an example of the allocation process of step S13 will be concretely described with reference to FIG. 9. FIG. 9 is a diagram illustrating an exemplary allocation process flow of the advertisement delivery management apparatus 1 according to an embodiment.

As illustrated in FIG. 9, when the delivery target user allocation process starts, the control unit 15 of the advertisement delivery management apparatus 1 first selects one of the non-allocated users which are smallest in the number of user attributes and not selected among the non-allocated users having the user attribute designated by the order request (step S21).

Next, the control unit 15 determines whether the number of the non-allocated users selected in step S21 is equal to the number of postings (step S22). When it is determined in this process that the number of the selected non-allocated users is equal to the number of postings (Yes in step S22), the control unit 15 causes the process to proceed to step S23. However, when it is determined that the number of the selected non-allocated users is not equal to the number of postings (No in step S22), the control unit 15 causes the process to return to step S21.

In step S23, the control unit 15 determines whether a limit mode is set. The setting of the limit mode may be performed, for example, by the administrator of the advertisement delivery management apparatus 1 using an operating unit (not illustrated) of the advertisement delivery management apparatus 1. Further, when the number of the non-allocated users in the future log table is certain number or less, the control unit 15 may set the control mode.

When it is determined that the limit mode is set (Yes in step S23), the control unit 15 determines whether there is a user attribute having a high decrease rate (step S24). In this process, the control unit 15 obtains a decrease rate of each user attribute of the non-allocated user before and after the non-allocated user selected in step S21 is allocated on the order request, and determines a user attribute in which the decrease rate is a certain value or more as the user attribute having the high decrease rate.

When it is determined that there is a user attribute in which the decrease rate is the certain value or more (Yes in step S24), the control unit 15 changes the non-allocated user to be selected (step S25). Specifically, the control unit 15 cancels the selection of the selected non-allocated user having the user attribute in which the decrease rate is the certain value or more, and selects one non-allocated user which is smallest in the number of user attributes among the non-allocated users which have a user attribute designated by the order request but have no user attribute in which the decrease rate is the certain value or more.

When the non-allocated user to be selected is changed in step S25, the control unit 15 causes the process to proceed to step S24 and determines whether there is a user attribute having a high decrease rate again. When it is determined in step S24 that there is no user attribute having the high decrease rate (No in step S24) or when it is determined in step S23 that the limit mode is not set (No in step S23), the control unit 15 ends the delivery target user allocation process.

### 4. MODIFIED EXAMPLE

In the embodiment, the allocating unit 25 performs the allocation process of allocating the delivery target user on the order request each time the order request is received from the advertiser terminal 3, but may perform the allocation process in units of two or more order requests. Further, the allocating unit 25 may perform the allocation process each time a total of the number of postings designated by the order request is a certain number or more. In this case, the accepting unit 24 can perform the allocation process efficiently and more appropriately while rapidly performing the acceptance process by accepting the order request each time the order request is received from the advertiser terminal 3.

Further, in order to help under the description, the above embodiment has been described in connection with the example in which the target period of time in which the future advertisement delivery destination is predicted is identical to the posting period of time of the order request. However, the target period of time in which the future advertisement delivery destination is predicted may not be identical to the posting period of time of the order request, and, for example, the target period of time in which the future advertisement delivery destination is predicted may be set in units of one day, and the posting period of time of the order request may be set in units of one day. Further, a part of the target period of time in which the future advertisement delivery destination is predicted may be used as the posting period of time of the order request.

Further, in the above embodiment, the process on the order request has been described, but the control unit 15 may receive a cancellation request from the advertiser terminal 3. In this case, the allocating unit 25 changes the allocated user to the non-allocated user on the advertisement delivery cancellation request received by the accepting unit 24 so that an increase in the total of the number of user attributes counted by the counting unit 23 can be maximized before and after the allocated user is changed to the non-allocated user on the cancellation request.

For example, when the cancellation request is received by the accepting unit 24, the allocating unit 25 acquires a total of the number of user attributes of the non-allocated users among a plurality of delivery target users set to the future log table from the counting unit 23 as a third total number.

Then, the allocating unit 25 changes the allocated users having the user attribute designated by the cancellation request to the non-allocated users by the number of postings designated by the cancellation request, and acquires a total of the number of user attributes of the changed non-allocated users from the counting unit 23 as a fourth total number.

The allocating unit 25 can maximize the fourth total number and maximize a result of subtracting the third total number from the fourth total number by sequentially selecting from the allocated user which is large in the number of user attributes. As the allocation of the delivery target user is cancelled on the cancellation request as described above, it is possible to increase choices of allocation of a delivery target user on a future order request.

Further, the above embodiment has been described in connection with the example in which the user attribute is designated in the order request, but even when the user attribute is not designated in the order request, the allocating unit 25 may allocate the delivery target user based on a total of the number of user attributes. For example, the allocating unit 25 can allocate the delivery target user so that a decrease in a total of the number of user attributes can be minimized by selecting the non-allocated user sequentially from the non-allocated user which is small in the number of held user attributes.

Further, the above embodiment has been described in connection with the example in which one or more user attributes are designated in the advertisement delivery order, but the user attribute may be selectively designated in the advertisement delivery order. For example, the advertisement delivery order may be given on the user of either the user attribute in which the attribute classification of “vehicle” or the user attribute in which the attribute classification is “travel.” In this case, similarly, the allocating unit 25 allocates the delivery target user so that the decrease in the total of the number of user attributes can be minimized.

### 5. EFFECTS

In the advertisement delivery management apparatus 1 according to the embodiment, the future log DB 14 (which corresponds to an example of a predictive information storage unit) stores information of user attributes of a plurality of delivery target users predicted as a future advertisement delivery destination, the counting unit 23 (which corresponds to an example of a counting unit) counts a total of the number of user attributes of delivery target user which are not allocated on the advertisement delivery order request among a plurality of delivery target users, and the allocating unit 25 (which corresponds to an example of an allocating unit) allocates the delivery target user on the advertisement delivery order request so that a decrease in a total of the number of user attributes counted by the counting unit 23 is minimized before and after the delivery target user is allocated on the advertisement delivery order request.

Through this configuration, choices of allocation of a delivery target user on the advertisement delivery order request increase, and the likelihood of acceptance of a future advertisement delivery order request increases, and thus it is possible to suppress sales opportunity loss.

Further, in the advertisement delivery management apparatus 1 according to the embodiment, the advertisement delivery order request includes information designating one or more user attributes, and the allocating unit 25 allocates the delivery target user having the user attribute designated by the order request on the advertisement delivery order request.

Through this configuration, it is possible to perform advertisement delivery to the user having the user attribute desired by the advertiser. Further, even when there is an advertisement delivery order request in which the user attribute is not designated, the delivery target user is allocated so that a decrease in a total of the number of user attributes is minimized, and thus it is possible to increase the likelihood of acceptance of a future advertisement delivery order request, and it is possible to suppress sales opportunity loss.

Further, in the advertisement delivery management apparatus 1 according to the embodiment, the counting unit 23 counts a total number using a combination of two or more user attributes in which the frequency of designation by the advertisement delivery order request is a threshold value or more as one user attribute.

Through this configuration, it is possible to allocate the user attribute on the order request using a combination of two or more user attributes in which the frequency of designation by the advertisement delivery order request is a threshold value or more, and thus it is possible to increase the likelihood of acceptance of a future advertisement delivery order request, and it is possible to suppress sales opportunity loss.

Further, in the advertisement delivery management apparatus 1 according to the embodiment, the allocating unit 25 allocates the delivery target user so that a decrease in a total of the number of user attributes counted by the counting unit 23 is minimized within a range in which a decrease in the number of user attributes other than the user attribute designated by the order request can be a certain level or less.

Through this configuration, it is possible to suppress a drastic decrease in the number of user attributes other than the user attribute designated by the order request, and thus it is possible to increase the likelihood of acceptance of a future advertisement delivery order request, and it is possible to suppress sales opportunity loss.

Further, in the advertisement delivery management apparatus 1 according to the embodiment, the allocating unit 25 allocates the delivery target user so that a decrease in a total of the number of user attributes is minimized within a range in which a decrease in an expectation value at which all the user attributes are allocated is a certain level or less when the user attributes are designated randomly or according to a certain rule on the order request.

Through this configuration, it is possible to prevent some user attributes from extremely decreasing, and thus it is possible to increase the likelihood of acceptance of a future advertisement delivery order request, and it is possible to suppress sales opportunity loss.

### 6. OTHERS

The advertisement delivery management apparatus 1 may be implemented by a plurality of server computers or may be implemented by calling an external platform or the like through an application programming interface (API), network computing, or the like according to a function. That is, the configuration of advertisement delivery management apparatus 1 can be flexibly changed. Further, the advertisement delivery management apparatus 1 and the information delivery apparatus 2 may be implemented by a single server computer.

According to the embodiment, it is possible to provide an advertisement delivery management apparatus and an advertisement delivery management method which are capable of appropriately allocating the delivery target user on the advertisement delivery order.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An advertisement delivery management apparatus, comprising:
a predictive information storage unit configured to store information including user attributes of a plurality of delivery target users predicted as a future advertisement delivery destination;
a counting unit configured to count a total of a number of user attributes of delivery target users which are not allocated on an advertisement delivery order request among the plurality of delivery target users; and
an allocating unit configured to allocate the delivery target user on the advertisement delivery order request so that a decrease in a total of the number of user attributes counted by the counting unit is minimized before and after the delivery target user is allocated on the advertisement delivery order request.

2. The advertisement delivery management apparatus according to claim 1,
wherein the advertisement delivery order request includes information designating one or more user attributes, and
the allocating unit allocates a delivery target user having the user attribute designated by the order request on the advertisement delivery order request.

3. The advertisement delivery management apparatus according to claim 2,
wherein the allocating unit allocates the delivery target user so that the decrease in the total of the number of user attributes counted by the counting unit is minimized within a range in which a decrease in the number of user attributes other than user attribute designated by the order request is a certain level or less.

4. The advertisement delivery management apparatus according to claim 2,
wherein the allocating unit allocates the delivery target user so that the decrease in the total of the number of user attributes is minimized within a range in which a decrease in an expectation value at which all user attributes are allocated is a certain level or less when a user attribute is designated by the order request randomly or according to a certain rule.

5. The advertisement delivery management apparatus according to claim 1,
wherein the counting unit counts the total number using a combination of two or more user attributes in which a frequency of designation by the advertisement delivery order request is a threshold value or more as one user attribute.

6. An advertisement delivery management method performed by a computer, comprising:
counting a total of a number of user attributes of delivery target users which are not allocated on an advertisement delivery order request from an advertiser among a plurality of delivery target users predicted as a future advertisement delivery destination; and
allocating the delivery target user on the advertisement delivery order request from the advertiser so that a decrease in a total of the number of user attributes counted in the counting is minimized before and after the delivery target user is allocated on the advertisement delivery order request.

7. The advertisement delivery management method according to claim 6,
wherein the advertisement delivery order request includes information designating one or more user attributes, and
the allocating includes allocating a delivery target user having the user attribute designated by the order request on the advertisement delivery order request.

8. The advertisement delivery management method according to claim 7,
wherein the allocating includes allocating the delivery target user so that the decrease in the total of the number of user attributes counted in the counting is minimized within a range in which a decrease in the number of user attributes other than user attribute designated by the order request is a certain level or less.

9. The advertisement delivery management method according to claim 7,
wherein the allocating includes allocating the delivery target user so that the decrease in the total of the number of user attributes is minimized within a range in which a decrease in an expectation value at which all user attributes are allocated is a certain level or less when a user attribute is designated by the order request randomly or according to a certain rule.

10. The advertisement delivery management method according to claim 6,
wherein the counting includes counting the total number using a combination of two or more user attributes in which a frequency of designation by the advertisement delivery order request is a threshold value or more as one user attribute.
